(19) United States
(12) Patent Application Publication
(10) Pub. No.: US 2023/0059772 A1
(43) Pub. Date: Feb. 23, 2023

(54) AUTONOMOUS VEHICLE AND METHOD FOR AUTONOMOUS VEHICLE TRAVEL

(71) Applicants: HYUNDAI MOTOR COMPANY, Seoul (KR); Kia Corporation, Seoul (KR)

(72) Inventor: Kyung Joo BANG, Seoul (KR)

(73) Assignees: HYUNDAI MOTOR COMPANY, Seoul (KR); Kia Corporation, Seoul (KR)

(21) Appl. No.: 17/673,421

(22) Filed: Feb. 16, 2022

(30) Foreign Application Priority Data
Aug. 17, 2021 (KR) 10-2021-0108245

(51) Int. Cl. B60W 60/00; B60W 40/04; G05D 1/00

(52) U.S. Cl. CPC B60W 60/0011; B60W 60/0015; B60W 40/04; G05D 1/0011; B60W 2555/60; B60W 2556/50; G05D 2201/0213

(57) ABSTRACT

The present disclosure relates to an autonomous vehicle and a method for traveling thereof. A travel situation is determined based on vehicle surroundings information during autonomous driving, a space around the vehicle is classified into a first space, a second space, and a third space based on the vehicle surroundings information, a travel route is created using at least one of the first space, the second space, and/or the third space based on the travel situation, and vehicle travel control is performed along the travel route.

### CROSS-REFERENCE TO RELATED APPLICATION

This application is based on and claims the benefit of priority to Korean Patent Application No. 10-2021-0108245, filed on Aug. 17, 2021, in the Korean Intellectual Property Office, the entire contents of which are incorporated herein by reference.

### TECHNICAL FIELD

The present disclosure relates to an autonomous vehicle and a method for autonomous vehicle travel.

### BACKGROUND

An autonomous vehicle is operating in compliance with traffic rules during autonomous driving. Such autonomous vehicle does not show a behavior of violating traffic rules, such as violating a center line, violating a safety zone, traveling on a shoulder, changing lanes through a solid line, violating a dedicated bus lane, or the like, in general travel situations. However, when being in compliance with the traffic rules may lead to a traffic accident, the autonomous vehicle must inevitably violate the traffic rules for safety of a passenger. In addition, travel may no longer be possible without violating the traffic rules because of an illegally parked and stopped vehicle or the like. In such situation, the autonomous vehicle transfers a control right to a driver to convert the autonomous driving to manual driving. However, when converting the autonomous driving to the manual driving in an emergency situation, accident avoidance may be difficult because of lack of time for the driver to react. In addition, it is impossible for a vehicle (an unmanned vehicle) traveling without the driver (or the passenger) on board or a vehicle that does not have a device necessary for the manual driving to convert the autonomous driving to the manual driving.

### SUMMARY

The present disclosure addresses the above-mentioned problems occurring in the prior art while maintaining advantages achieved by the prior art.

An aspect of the present disclosure provides an autonomous vehicle that, in a situation in which traffic rule violation is unavoidably required during autonomous driving, creates an alternative route using a space where travel is prohibited in a traffic rule compliance situation, and travels along the created alternative route, and a method for autonomous vehicle travel.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, a method for autonomous vehicle travel includes determining, by a processor, a travel situation based on vehicle surroundings information during autonomous driving, classifying, by a processor, a space around the vehicle into a first space, a second space, and a third space based on the vehicle surroundings information, creating, by a processor, a travel route using at least one of the first space, the second space, and the third space based on the travel situation, and performing, by a processor, vehicle travel control along the travel route.

In one embodiment, the first space may be a space where the autonomous vehicle travel is possible while complying with traffic rules.

In one embodiment, the second space may be a space where the autonomous vehicle travel is possible regardless of traffic rules.

In one embodiment, the third space may be at least a portion of the second space where avoidance travel is possible.

In one embodiment, the determining of the travel situation may include determining, by the processor, whether the travel situation is a first travel situation where accident avoidance is impossible based on the vehicle surroundings information during the autonomous vehicle travel along a normal route planned based on the first space, and determining, by the processor, whether the travel situation is a second travel situation where the autonomous vehicle travel is impossible along the normal route.

In one embodiment, the creating of the travel route may include creating, by the processor, an emergency route using at least one of the first space and the second space when the travel situation is the first travel situation, and creating, by the processor, an avoidance route using at least one of the first space and the third space when the travel situation is the second travel situation.

In one embodiment, the performing of the vehicle travel control may include transmitting, by the processor, the emergency route to a remote control center to request approval, and transmitting, by the processor, the emergency route to an autonomous driving controller and performing, by the processor, emergency route travel until receiving a rejection for the emergency route from the remote control center.

In one embodiment, the performing of the vehicle travel control may include transmitting, by the processor, the avoidance route to a remote control center to request approval, and transmitting, by the processor, the avoidance route to an autonomous driving controller to perform avoidance route travel when the avoidance route is approved by the remote control center.

In one embodiment, the performing of the vehicle travel control may further include determining, by the processor, whether the accident avoidance has been completed when a remote control command is not received from the remote control center, and returning, by the processor, to the first space when the accident avoidance has been completed.

In one embodiment, the performing of the vehicle travel control may further include stopping, by the processor, emergency route travel or the avoidance route travel and controlling, by the processor, the autonomous vehicle travel in response to the remote control command when the remote control command is received from the remote control center.

According to another aspect of the present disclosure, an autonomous vehicle includes a detection device for detecting vehicle surroundings information, and a processor configured to classify a space around the vehicle into a first space, a second space, and a third space based on the vehicle surroundings information, and the processor is configured to determine a travel situation based on the vehicle surroundings information during autonomous driving, create a travel route using at least one of the first space, the second space, and the third space based on the travel situation, and perform vehicle travel control along the travel route.

In one embodiment, the first space may be a space where autonomous vehicle travel is possible while complying with traffic rules.

In one embodiment, the second space may be a space where autonomous vehicle travel is possible regardless of traffic rules.

In one embodiment, the third space may be at least a portion of the second space where avoidance travel is possible.

In one embodiment, the processor may be configured to determine whether the travel situation is a first travel situation where accident avoidance is impossible based on the vehicle surroundings information during autonomous vehicle travel along a normal route planned based on the first space, and determine whether the travel situation is a second travel situation where the autonomous vehicle travel is impossible along the normal route.

In one embodiment, the processor may be configured to create an emergency route using at least one of the first space and the second space when the travel situation is the first travel situation, and create an avoidance route using at least one of the first space and the third space when the travel situation is the second travel situation.

In one embodiment, the processor may be configured to transmit the emergency route to a remote control center to request approval, and transmit the emergency route to an autonomous driving controller and perform emergency route travel until receiving a rejection for the emergency route from the remote control center.

In one embodiment, the processor may be configured to transmit the avoidance route to a remote control center to request approval, and transmit the avoidance route to an autonomous driving controller to perform avoidance route travel when the avoidance route is approved by the remote control center.

In one embodiment, the processor may be configured to determine whether the accident avoidance has been completed when a remote control command is not received from the remote control center, and return to the first space when the accident avoidance has been completed.

In one embodiment, the processor may be configured to stop emergency route travel or the avoidance route travel and control the autonomous vehicle travel of the vehicle in response to the remote control command when the remote control command is received from the remote control center.

### BRIEF DESCRIPTION OF THE DRAWINGS

The above and other objects, features and advantages of the present disclosure will be more apparent from the following detailed description taken in conjunction with the accompanying drawings:

FIG. 1 is a block diagram illustrating an autonomous vehicle according to embodiments of the present disclosure;

FIG. 2 is a diagram illustrating a logical configuration of a travel route creation module according to embodiments of the present disclosure;

FIGS. 3 to 11 are diagrams for illustrating a travel route creation method according to embodiments of the present disclosure;

FIG. 12 is a flowchart illustrating a travel method of an autonomous vehicle according to embodiments of the present disclosure;

FIG. 13 is a flowchart illustrating a travel situation determination process according to embodiments of the present disclosure;

FIG. 14 is a flowchart illustrating a process of controlling travel in an emergency situation according to embodiments of the present disclosure;

FIG. 15 is a flowchart illustrating travel control in an avoidance situation according to embodiments of the present disclosure; and

FIG. 16 is a block diagram illustrating a computing system that executes a travel method of an autonomous vehicle according to embodiments of the present disclosure.

### DETAILED DESCRIPTION

Hereinafter, some embodiments of the present disclosure will be described in detail with reference to the exemplary drawings. In adding the reference numerals to the components of each drawing, it should be noted that the identical or equivalent component is designated by the identical numeral even when they are displayed on other drawings. Further, in describing the embodiment of the present disclosure, a detailed description of the related known configuration or function may not be provided in order not to unnecessarily interfere with the understanding of the embodiment of the present disclosure.

In describing the components of the embodiment according to the present disclosure, terms such as first, second, A, B, (a), (b), and the like may be used. These terms are merely intended to distinguish the components from other components, and the terms do not limit the nature, order or sequence of the components. Unless otherwise defined, all terms including technical and scientific terms used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

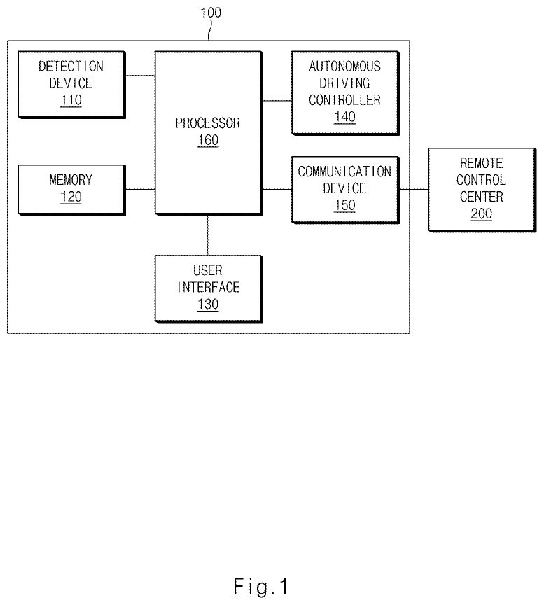

FIG. 1 is a block diagram illustrating an autonomous vehicle according to embodiments of the present disclosure.

Referring to FIG. 1, an autonomous vehicle (hereinafter, a vehicle) 100 may include a detection device 110, a memory 120, a user interface (human interface device) 130, an autonomous driving controller 140, a communication device 150, and a processor 160.

The detection device 110 may detect (sense) vehicle surroundings information using at least one sensor and/or at least one electric control unit (ECU) mounted on the vehicle 100. In this connection, the vehicle surroundings information may include vehicle omnidirectional information such as an object and/or a shape of a road around the vehicle. As the at least one sensor, a sensor such as an omnidirectional sensor, an advanced driver assistance system (ADAS) sensor, a light detection and ranging (LiDAR), a radio detecting and ranging (radar), an ultrasonic sensor, and/or a camera may be used.

The memory 120 may be a non-transitory storage medium that stores instructions and/or logic executed by the processor 160. The memory 120 may include at least one of storage media (recording media) such as a flash memory, a hard disk, a solid state disk (SSD), a secure digital card (SD card), a random access memory (RAM), a static random access memory (SRAM), a read only memory (ROM), a programmable read only memory (PROM), an electrically erasable and programmable ROM (EEPROM), an erasable and programmable ROM (EPROM), an embedded multimedia card (eMMC), and/or a universal flash storage (UFS).

The user interface 130 may support the vehicle 100 and a user to exchange information with each other. The user interface 130 may include an interface device such as a keyboard, a keypad, a button, a switch, a touchpad, a microphone, a liquid crystal display (LCD), an organic light-emitting diode (OLED) display, a flexible display, a three-dimensional display (3D display), a transparent display, a head-up display (HUD), a touch screen, a speaker, and/or a haptic module.

The autonomous driving controller 140 may control a behavior, for example, acceleration, deceleration, steering, and/or braking, of the vehicle 100 to follow a determined travel route. In addition, the autonomous driving controller 140 may determine whether the route following is possible based on the vehicle surroundings information. The autonomous driving controller 140 may control the behavior of the vehicle 100 in response to a remote control command transmitted from a remote control center 200. The autonomous driving controller 140 may execute the remote control command with the highest priority. The autonomous driving controller 140 may return to travel based on a normal route when remote control of the remote control center 200 is terminated. The controller 140 may be implemented as a memory configured to store algorithm(s) for performing the above operations or store data for a program that reproduces the algorithm(s), and may be further implemented as a processor configured to perform the above operations when executing the algorithm(s) or data stored in the memory.

The communication device 150 may support wireless communication between the vehicle 100 and a server of the remote control center 200. The communication device 150 may use at least one of communication technologies such as a wireless Internet (e.g., a wi-fi), a short-range communication (e.g., a Bluetooth, a Zigbee, and an infrared communication), and/or a mobile communication. The communication device 150 may transmit a route approval request and/or a remote control request to the remote control center 200 in response to an instruction of the processor 160. In addition, the communication device 150 may receive a route approval result (whether a route is approved) and/or the remote control command transmitted from the remote control center 200. The remote control center 200 may be an authority authorized to approve and/or supervise violation of traffic rules. For example, the remote control center 200 may be a police traffic control center or the like.

The processor 160 may control an overall operation of the vehicle 100. The processor 160 may be implemented as at least one of processing devices such as an application specific integrated circuit (ASIC), a digital signal processor (DSP), a programmable logic device (PLD), a field programmable gate array (FPGA), a central processing unit (CPU), a microcontroller, and/or a microprocessor.

The processor 160 may create a travel route based on the vehicle surroundings information. The processor 160 may transmit the created travel route to the autonomous driving controller 140.

The processor 160 may acquire the vehicle surroundings information through the detection device 110 when the vehicle 100 initiates autonomous driving. The processor 160 may classify a space around the vehicle into a first space, a second space, and a third space based on the vehicle surroundings information and the traffic rules. The first space may be a space in which the travel is possible while complying with the traffic rules, the second space may be any space in which the travel is possible regardless of the traffic rules, and the third space may be at least a portion of the second space in which avoidance travel is possible.

The processor 160 may create the travel route using at least one of the classified first space, second space, and third space. The processor 160 may create a normal route (a first route) using the first space, an emergency route (a second route) using the second space, and/or an avoidance route (a third route) using the third space. The processor 160 may select the normal route, the emergency route, or the avoidance route as the travel route based on the vehicle surroundings information and whether the route following is possible determined by the autonomous driving controller 140. The processor 160 may select the normal route as the travel route in a situation in which the route following is possible. The processor 160 may select (determine) the emergency route or the avoidance route as the travel route (the alternative route) instead of the normal route based on the vehicle surroundings information in a situation in which the route following is impossible.

The processor 160 may transmit the determined travel route to the autonomous driving controller 140 when the travel route is determined (selected). In addition, the processor 160 may transmit the route approval request including the determined travel route to the remote control center 200. The processor 160 may transmit the determined travel route based on whether the route is approved by the remote control center 200 to the autonomous driving controller 140. In other words, the processor 160 may transmit the travel route approved by the remote control center 200 to the autonomous driving controller 140. The processor 160 may make a request for the remote control to the remote control center 200 when it is impossible to return to the normal route while traveling along the emergency route or the avoidance route.

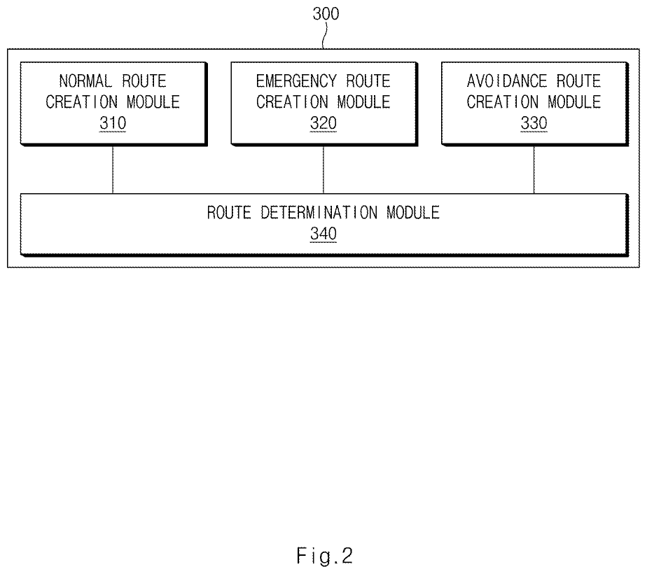

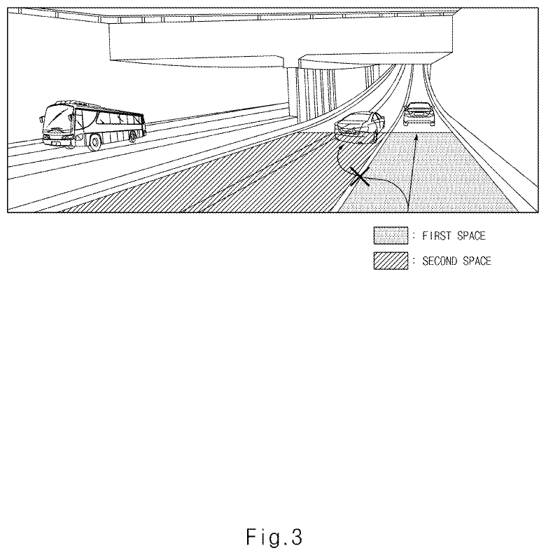

FIG. 2 is a diagram illustrating a logical configuration of a travel route creation module according to embodiments of the present disclosure. FIGS. 3 to 11 are diagrams for illustrating a travel route creation method according to embodiments of the present disclosure.

A travel route creation module 300 may be implemented as hardware, software, or a combination thereof executed by the processor 160 shown in FIG. 1. The software may be stored in a storage medium, for example, the memory 120.

The travel route creation module 300 may include a normal route creation module 310, an emergency route creation module 320, an avoidance route creation module 330, and a route determination module 340 as shown in FIG. 2.

The normal route creation module 310 may create the normal route on which the vehicle 100 may travel while complying with the traffic rules based on the vehicle surroundings information. In this connection, the normal route may be created by utilizing only the first space.

For example, when the vehicle 100 travels in a section in which a left line of the travel lane is a solid line where lane change is prohibited and a right side of the travel lane is a wall surface as shown in FIG. 3, although a left lane of the travel lane is a travelable lane, lane change to the left lane in the corresponding section violates the traffic rules. Accordingly, a space of the left lane is not included in the first space (a normal space). In addition, the right side of the travel lane, which is a travel-impossible-space because of the wall, is not included in the first space. In this case, the normal route creation module 310 is not able to create a route including left and right lane changes as the normal route.

The emergency route creation module 320 may create the emergency route for traveling at the risk of violating the traffic rules in an emergency situation in which accident avoidance is impossible when traveling on the normal route. The emergency route may be created by utilizing at least one of the first space and/or the second space. In this connection, the second space may include a portion or an entirety of a travelable space outside the first space.

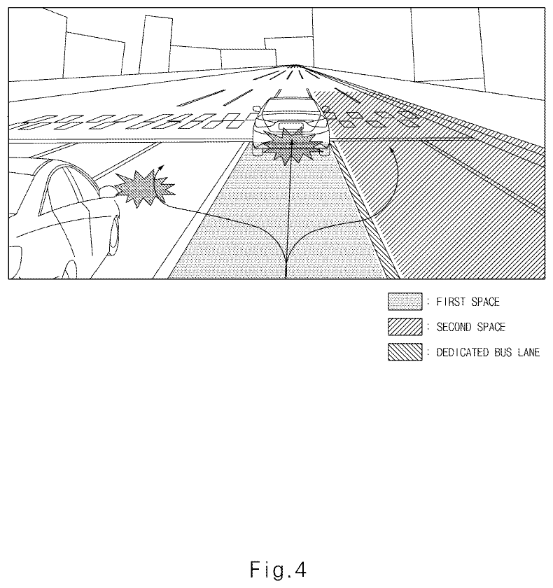

For example, as shown in FIG. 4, in a situation in which the vehicle 100 travels in a section in which the left line of the travel lane is the solid line and a right lane is a dedicated bus lane, the left lane is the travel-impossible-space in which there is a risk of collision with a traveling vehicle, and the right lane, which is the dedicated bus lane, is a space travelable in the emergency situation as the travel itself is possible, that is, the second space (an emergency space). In this case, the first space may include only the lane on which the vehicle 100 is traveling. In this connection, when it is impossible to avoid an accident with a vehicle at the front when traveling on the normal route, the emergency route creation module 320 may create the emergency route using the second space on the right side, that is, the dedicated bus lane, even though the traffic rules are violated. The emergency route creation module 320 may create the route to return to the first space when the emergency situation is resolved. The emergency route creation module 320 may terminate the emergency route creation when the vehicle 100 returns to the first space.

The avoidance route creation module 330 may create a route, that is the avoidance route, for the avoidance travel at the risk of violating the traffic rules in a situation in which it is no longer possible to travel in the first space because of an illegally parked or stopped vehicle and/or a fallen object, which is not the emergency situation. The avoidance route may be created by utilizing at least one of the first space and/or the third space. The third space may be at least a portion or the entirety of the travelable space outside the first space. Because an avoidance situation has a low risk level compared to the emergency situation, the third space may be a space excluding a portion defined in advance in the second space.

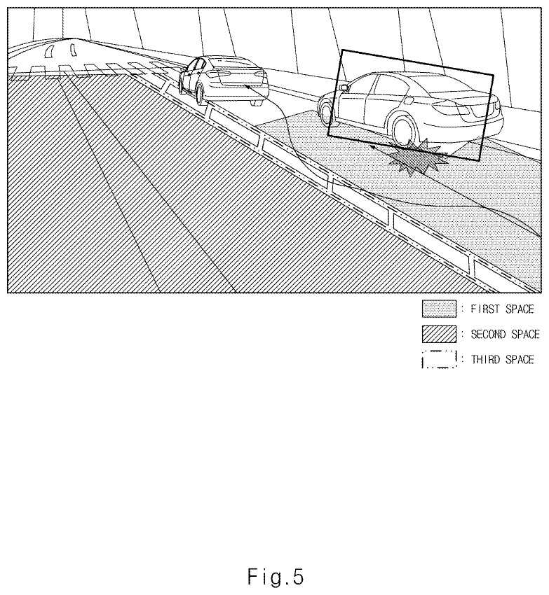

For example, referring to FIG. 5, in a situation in which the vehicle 100 travels on a one-lane road that permits one-way travel, a right side of the travel lane, which is a pedestrians road, is the travel-impossible-space, and a left lane of the travel lane corresponds to the second space because the travel itself is possible, but a center line and a safety zone must be invaded for left lane travel. In this case, the first space may include only the travel lane on which the vehicle 100 is traveling. When a space on an opposite side around the center line is defined in advance to be excluded from an avoidance space, the third space may include only the safety zone. In this connection, when it is no longer possible to travel on the normal route because of the illegally parked or stopped vehicle on a roadside, there is no choice but to stop and wait with no time limit, and passage of other vehicles at the rear is also obstructed. Accordingly, the avoidance route creation module 330 may create the avoidance route that passes through the safety zone, that is, the third space even when the traffic rules are violated.

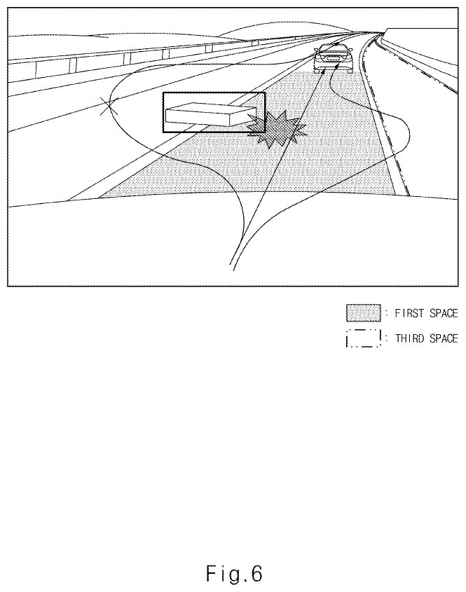

As shown in FIG. 6, in a situation in which the vehicle 100 is not able to travel on the normal route based on the first space because of the fallen object on the road, when the travel is not possible on a left lane of the travel lane because there is a risk of collision with a vehicle traveling on the corresponding lane, and there is a shoulder where the traffic rule violation or the travel itself is possible on a right side of the travel lane, the avoidance route creation module 330 may classify the shoulder as the third space, and create, by utilizing the classified third space, the avoidance route where it is possible to continue to travel by avoiding the fallen object on the road.

In addition, when it is difficult to be recognized as an emergency evacuation because the risk level is low, the avoidance route creation module 330 may transmit an approval request (the route approval request) for the created avoidance route to the remote control center 200. The vehicle 100 may wait at a current location until an affirmative response (i.e., the approval) to the route approval request of the avoidance route creation module 330 is received.

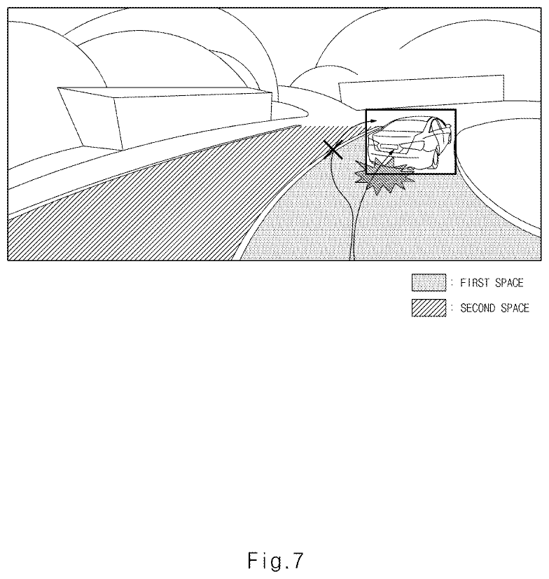

For example, in a situation in which the vehicle 100 is not able to travel on the normal route because of the illegally parked or stopped vehicle as in FIG. 7, when a left line of the travel lane is the center line, a left lane may be classified as the second space instead of the third space. Therefore, the avoidance route creation module 330 is not able to create the avoidance route because of absence of the third space. In this connection, the vehicle 100 may wait at the current location.

The avoidance route creation module 330 may create the route to return to the first space when the avoidance situation is resolved. The avoidance route creation module 330 may terminate the avoidance route creation when the vehicle 100 returns to the first space.

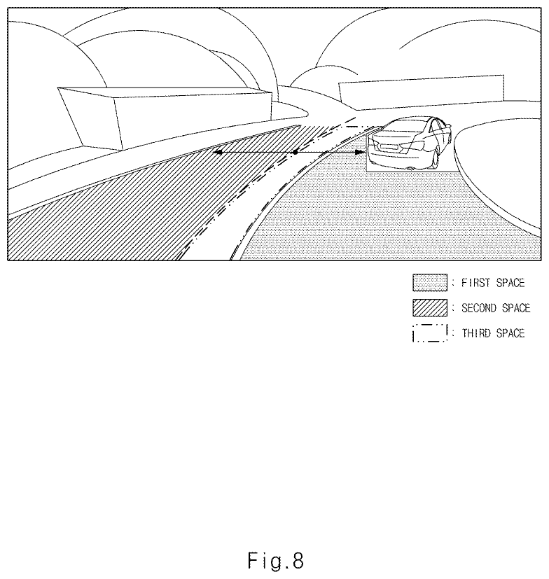

The third space may include at least a portion of the second space that satisfies a predefined condition. For example, in a case in which a minimum width of a space including the first space and the second space excluding a space occupied by the illegally parked or stopped vehicle allows cross passage of two vehicles in the situation of traveling on the one-lane road that permits the one-way travel as shown in FIG. 8, the avoidance route creation module 330 may set the second space on a side of the vehicle 100 based on a point of ½ the width of the space including the first space and the second space as the third space. In one example, when the minimum width of the space including the first space and the second space does not allow the cross passage of the two vehicles, the avoidance route creation module 330 may not set the third space. This is to prevent a situation in which, when the vehicle 100 encounters another vehicle traveling in an opposite direction, the two vehicles are no longer able to travel from occurring.

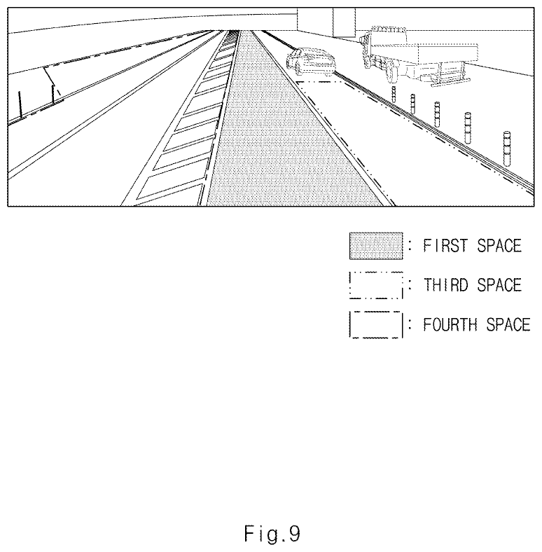

As another example, referring to FIG. 9, when there is a travelable normal lane in the second space, the avoidance route creation module 330 may set the opposite side around the center line, the dedicated bus lane, and/or the safety zone of the second space as an exclusion space, that is, a fourth space, and exclude the set fourth space when setting the third space. This is to avoid using a more dangerous space because there is another space to which the avoidance is possible.

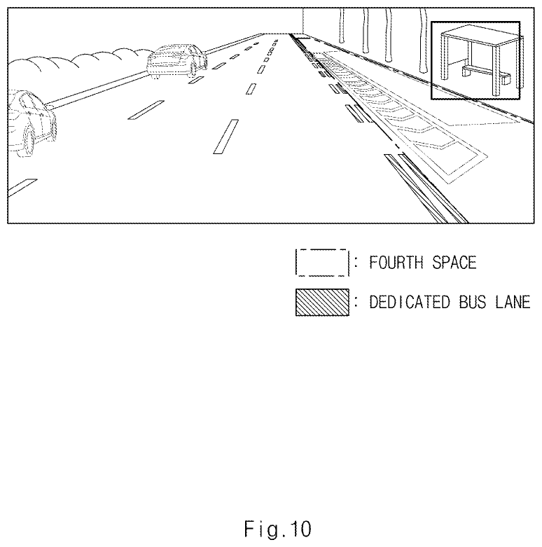

As another example, referring to FIG. 10, when the dedicated bus lane exists on the travel road, the avoidance route creation module 330 may set the corresponding dedicated bus lane as the fourth space and exclude the corresponding dedicated bus lane from the third space when there is a bus stop around the dedicated bus lane within a certain distance. In other words, the avoidance route creation module 330 may set the corresponding dedicated bus lane as the third space only when there is no bus stop around the dedicated bus lane within the certain distance. This is to prevent bus boarding and alighting interference and delay in returning to the first space, and to protect passengers around the bus stop.

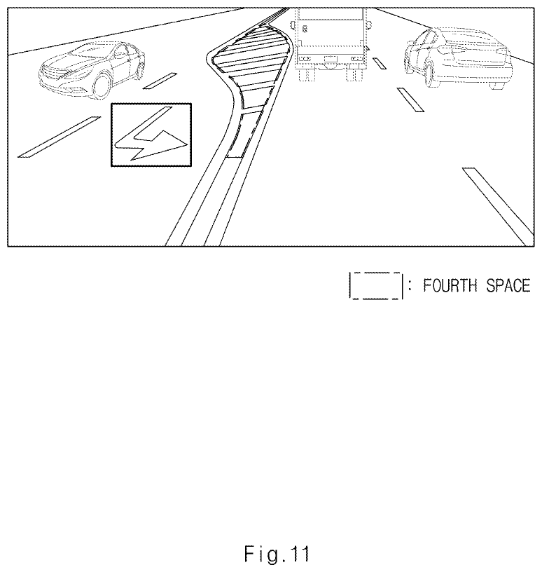

As another example, as shown in FIG. 11, when the safety zone is installed at an intersection, the avoidance route creation module 330 may set the safety zone as the third space only when the vehicle 100 travels in the same direction as a roundabout. The avoidance route creation module 330 may exclude the safety zone from the third space by setting the safety zone as the fourth space when the vehicle 100 travels in a reverse direction to the roundabout. This is because it is more difficult to predict invasion of the safety zone by the vehicle traveling in the reverse direction to the roundabout.

The route determination module 340 may perform a travel situation determination after initially starting with a normal route travel state. The route determination module 340 may select one of the normal route, the emergency route, and the avoidance route based on the travel situation. The route determination module 340 may make a request for approval of the selected route or the remote control of the vehicle to the remote control center 200 when necessary.

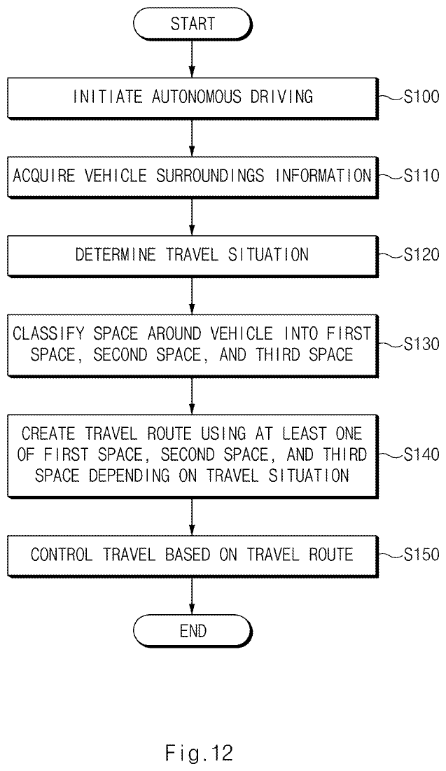

FIG. 12 is a flowchart illustrating a travel method of an autonomous vehicle according to embodiments of the present disclosure.

The vehicle 100 may initiate the autonomous driving (S100). The processor 160 may create the normal route (the first route) utilizing the first space when the autonomous driving initiating event occurs. The processor 160 may transmit the created normal route to the autonomous driving controller 140 to allow the vehicle 100 to initiate the autonomous driving. The autonomous driving controller 140 may control the autonomous driving of the vehicle 100 by following the normal route.

The processor 160 may acquire the vehicle surroundings information using the detection device 110 during the normal route travel (S110). The vehicle surroundings information may include the vehicle omnidirectional information such as the object and/or the shape of the road around the vehicle.

The processor 160 may determine the travel situation based on the vehicle surroundings information during the normal route travel (S120). The processor 160 may determine the travel situation during the normal route travel as a situation (a first travel situation) in which the accident avoidance is impossible or a situation (a second travel situation) in which the normal route travel is impossible.

The processor 160 may classify the space around the vehicle into the first space, the second space, and the third space based on the vehicle surroundings information (S130). In this connection, the first space may be the space in which the travel is possible while complying with the traffic rules, the second space may be any space in which the travel is possible regardless of the traffic rules, and the third space may be at least the portion of the second space in which the avoidance travel is possible.

The processor 160 may create the travel route using at least one of the classified first space, second space, and third space (S140). The processor 160 may determine emergency control or avoidance control based on the travel situation. The processor 160 may determine the emergency control when the travel situation is the situation in which the accident avoidance is impossible, and may determine the avoidance control when the travel situation is the situation in which the normal route travel is impossible. When the emergency control is determined, the processor 160 may create the emergency route (the second route) as the travel route using at least one of the first space and/or the second space. When the avoidance control is determined, the processor 160 may create the avoidance route (the third route) as the travel route using at least one of the first space and/or the third space.

The processor 160 may control the travel of the vehicle 100 based on the created travel route (S150). The processor 160 may transmit the created travel route, that is, the normal route, the emergency route, or the avoidance route to the autonomous driving controller 140. The autonomous driving controller 140 may control the behavior of the vehicle 100 to perform the autonomous driving along the travel route.

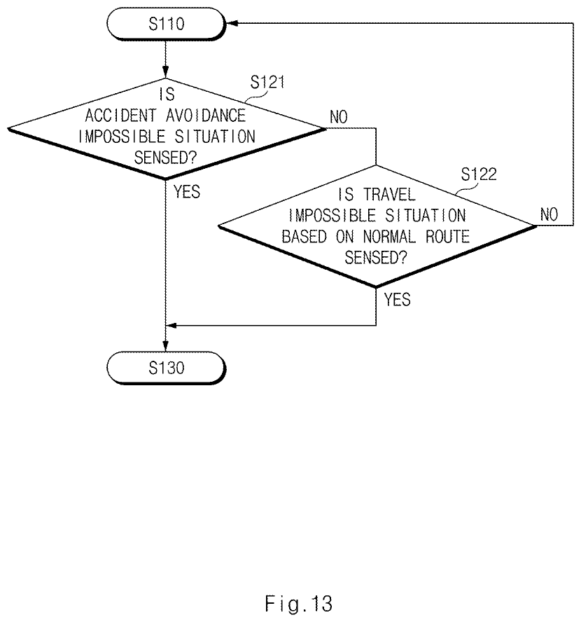

FIG. 13 is a flowchart illustrating a travel situation determination process according to embodiments of the present disclosure.

Referring to FIG. 13, the processor 160 may determine whether the accident avoidance impossible situation is sensed based on the vehicle surroundings information during the normal route travel (S121). The processor 160 may sense an occurrence of an accident risk in the vehicle 100 using known collision risk recognition technology and/or collision avoidance technology, and may determine whether the corresponding accident is avoidable. When the accident avoidance is impossible, the processor 160 may determine a current situation as the accident avoidance impossible situation, that is, the emergency situation. The processor 160 may determine the emergency control when the current situation is determined as the emergency situation. In this connection, the emergency control may be defined as travel control using the emergency route.

When the accident avoidance impossible situation is not sensed in S121, the processor 160 may determine whether the travel impossible situation based on the normal route is sensed (S122). When there is no risk of the accident or the accident avoidance is possible, the processor 160 may determine whether the travel of the vehicle is impossible while performing the normal route travel. When the vehicle is not able to travel, the processor 160 may determine the current situation as the normal route travel impossible situation, that is, the avoidance situation. For example, the processor 160 may determine the current situation as the normal route travel impossible situation when the travel of the vehicle using the first space is no longer possible because of the illegally parked or stopped vehicle and/or the fallen object on the road during the normal route travel. The processor 160 may determine the avoidance control when the normal route travel impossible situation is determined. The avoidance control may be defined as travel control using the avoidance route.

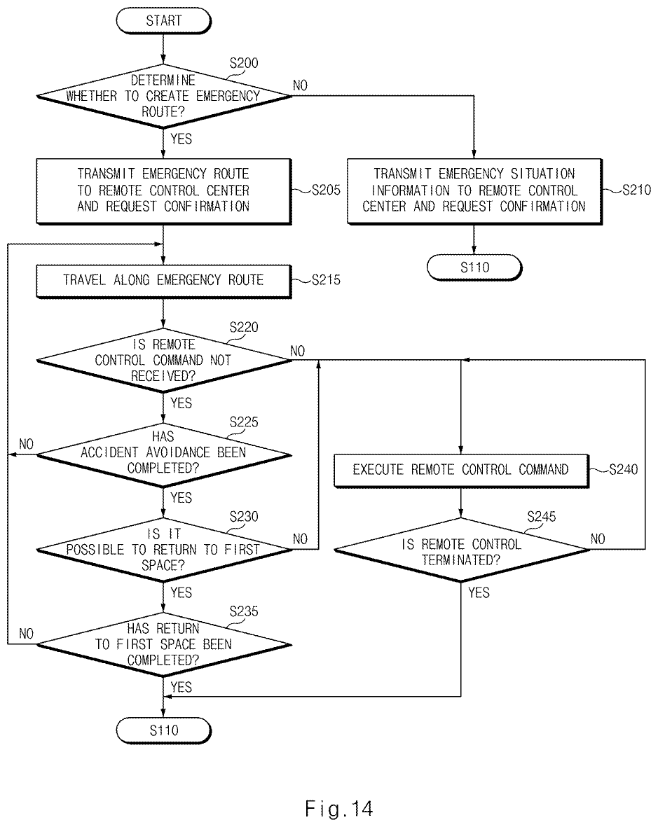

FIG. 14 is a flowchart illustrating a process of controlling travel in an emergency situation according to embodiments of the present disclosure.

When the emergency control is determined based on the travel situation, the processor 160 may determine whether to create the emergency route (S200). In other words, the processor 160 may determine whether the emergency route creation by the emergency route creation module 320 is possible.

The processor 160 may request confirmation by transmitting the created emergency route to the remote control center 200 when the emergency route is created (S205). In other words, the processor 160 may make a request for the approval for the created emergency route to the remote control center 200.

The processor 160 may request the confirmation while transmitting emergency situation information to the remote control center 200 when the emergency route is not created (S210). Thereafter, the processor 160 may return to S110 to maintain the normal route travel and acquire the vehicle surroundings information.

After S205, the processor 160 may perform the travel along the emergency route (S215). The processor 160 may select (choose) the emergency route created by the emergency route creation module 320 as the travel route and transmit the selected emergency route to the autonomous driving controller 140. The autonomous driving controller 140 may control the vehicle behavior, so that the vehicle 100 follows the emergency route.

The processor 160 may determine whether the remote control command is not received from the remote control center 200 while performing the emergency route travel (S220). When receiving an emergency route creation notification from the vehicle 100, the remote control center 200 may determine appropriateness of the emergency route based on a predetermined standard. The remote control center 200 may transmit the remote control command to the vehicle 100 when it is determined that the emergency route is inappropriate. In addition, the remote control center 200 may transmit a rejection for the emergency route when it is determined that the emergency route is inappropriate. The processor 160 may transmit the emergency route to the autonomous driving controller 140 to travel along the emergency route until receiving the a rejection for the emergency route from the remote control center 200.

When the remote control command is not received, the processor 160 may determine whether the accident avoidance has been completed (S225). When the accident avoidance has not been completed, the processor 160 may continuously create the emergency route and transmit the created emergency route to the autonomous driving controller 140 to maintain the emergency route travel (S215).

When the accident avoidance has been completed, the processor 160 may determine whether it is possible to return to the first space (S230). When the accident avoidance has been completed, the processor 160 may determine whether it is possible to return to the first space from the emergency route (the second space).

When it is possible to return to the first space, the processor 160 may determine whether the return to the first space has been completed (S235). When it is possible to return to the first space, the processor 160 may create a route for returning to the first space (a return route) and transmit the return route to the autonomous driving controller 140. The autonomous driving controller 140 may perform the return to the first space of the vehicle 100 along the return route. The processor 160 may maintain the emergency route travel until the return to the first space is completed, and may convert the emergency route travel to the normal route travel when the return to the first space has been completed.

When the remote control command is received in S220 or when it is impossible to return to the first space in S230, the processor 160 may allow the autonomous driving controller 140 to execute the remote control command (S240). When the remote control is determined, the processor 160 may make a request for the remote control to the remote control center 200. When receiving the remote control command from the remote control center 200, the autonomous driving controller 140 may execute the corresponding remote control command with the highest priority. The autonomous driving controller 140 may stop the emergency route travel immediately when receiving the remote control command and execute the remote control command.

The processor 160 may determine whether the remote control by the remote control center 200 is terminated (S245). The processor 160 may return to the normal route travel when the remote control is terminated.

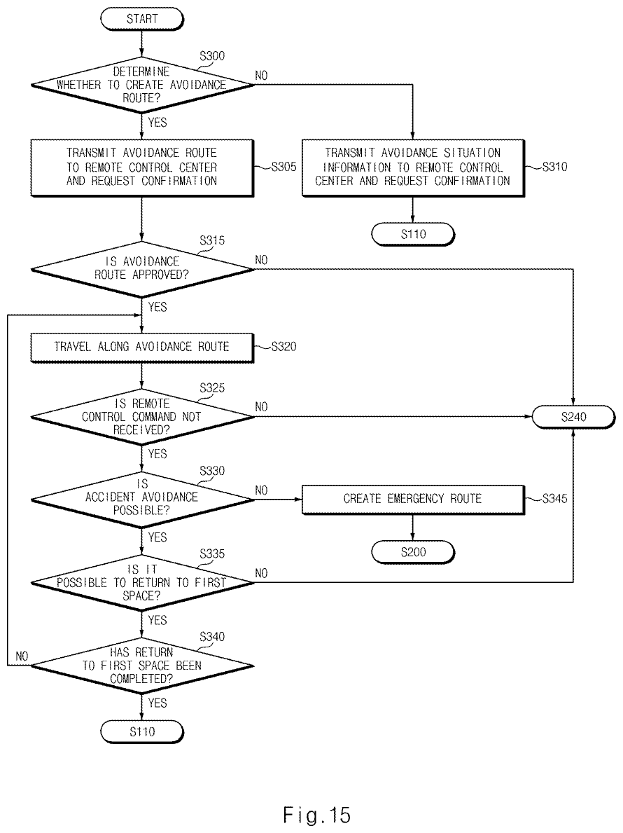

FIG. 15 is a flowchart illustrating travel control in an avoidance situation according to embodiments of the present disclosure.

When the avoidance control is determined based on the travel situation, the processor 160 may determine whether to create the avoidance route (S300). The processor 160 may determine whether the avoidance route creation by the avoidance route creation module 330 is possible.

When the avoidance route is created, the processor 160 may request confirmation while transmitting the avoidance route to the remote control center 200 (S305). When the avoidance route creation is possible, the processor 160 may request approval by transmitting the avoidance route created by the avoidance route creation module 330 to the remote control center 200.

When the avoidance route is not created, the processor 160 may request confirmation while transmitting avoidance situation information to the remote control center 200 (S310). The processor 160 may return to the normal route travel after requesting the confirmation (approval). Because it is the situation in which the travel is impossible during the normal route travel, the vehicle 100 may wait at the current location until the travel situation is changed.

After S305, the processor 160 may determine whether the avoidance route is approved (S315). Because the avoidance situation has the lower risk level than the emergency situation, the vehicle 100 may wait at the current location until receiving a result indicating the route approval from the remote control center 200.

When the avoidance route is approved, the processor 160 may perform the travel with the avoidance route (S320). The processor 160 may transmit the avoidance route created by the avoidance route creation module 330 to the autonomous driving controller 140 as the travel route. The autonomous driving controller 140 may control the travel of the vehicle 100 based on the avoidance route.

The processor 160 may determine whether the remote control command is not received during the avoidance route travel (S325). The remote control center 200 may transmit the remote control command to the vehicle 100 when it is determined that the current travel state is inappropriate during the avoidance route travel.

When the remote control command is not received, the processor 160 may determine whether the current situation is the situation in which the accident avoidance is possible during the avoidance route travel (S330).

The processor 160 may determine whether it is possible to return to the first space when the accident avoidance is possible (S335). In addition, the processor 160 may determine whether it is possible to return to the first space even when there is no risk of the accident during the avoidance route travel. The processor 160 may determine whether it is possible to create the return route for returning to the first space. The processor 160 may determine that it is possible to return to the first space when the return route creation is possible. The processor 160 may determine that it is impossible to return to the first space when the return route creation is impossible.

When it is possible to return to the first space, the processor 160 may determine whether the return to the first space has been completed (S340). The processor 160 may return to the normal route travel when the return to the first space has been completed, and may maintain the avoidance route travel when the return to the first space has not been completed.

When the avoidance route is not approved in S315, when the remote control command is received in S325, or when it is impossible to return to the first space in S335, the processor 160 may perform S240 and below. When receiving the remote control command during the avoidance route travel, the processor 160 may immediately stop the avoidance route travel, and control the travel of the vehicle 100 in response to the remote control command. When the remote control command is received in S325 or when it is impossible to return to the first space in S335, the processor 160 may stop the avoidance route travel and wait until the remote control command is received from the remote control center 200. Thereafter, when the remote control command is received from the remote control center 200, the processor 160 may execute the corresponding remote control command.

When the accident avoidance is impossible in S330, the processor 160 may create the emergency route (S345). Thereafter, the processor 160 may perform S200 and below. In other words, when the accident avoidance is impossible during the avoidance route travel, the processor 160 may determine whether to perform the emergency route travel by determining whether the emergency route creation is possible.

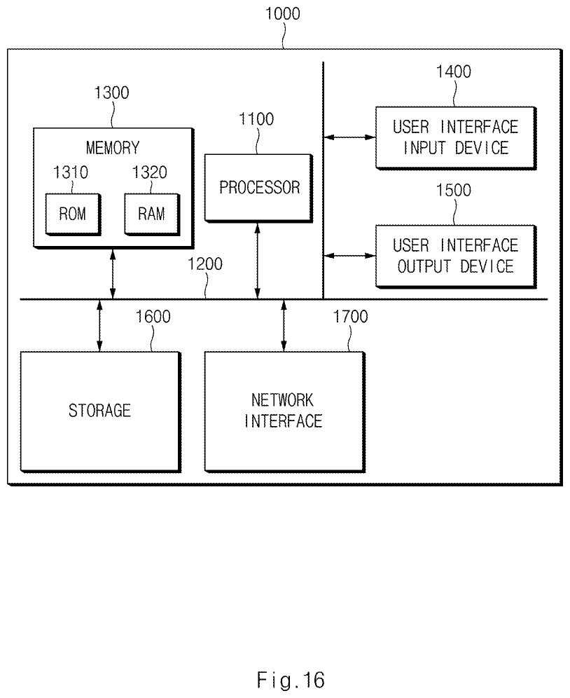

FIG. 16 is a block diagram illustrating a computing system that executes a travel method of an autonomous vehicle according to embodiments of the present disclosure.

Referring to FIG. 16, a computing system 1000 may include at least one processor 1100, a memory 1300, a user interface input device 1400, a user interface output device 1500, storage 1600, and a network interface 1700 connected via a bus 1200.

The processor 1100 may be a central processing unit (CPU) or a semiconductor device that performs processing on commands stored in the memory 1300 and/or the storage 1600. The memory 1300 and the storage 1600 may include various types of volatile or non-volatile storage media. For example, the memory 1300 may include a ROM (Read Only Memory) 1310 and a RAM (Random Access Memory) 1320.

Thus, the operations of the method or the algorithm described in connection with the embodiments disclosed herein may be embodied directly in hardware or a software module executed by the processor 1100, or in a combination thereof. The software module may reside on a storage medium (that is, the memory 1300 and/or the storage 1600) such as a RAM, a flash memory, a ROM, an EPROM, an EEPROM, a register, a hard disk, a removable disk, and a CD-ROM. The exemplary storage medium is coupled to the processor 1100, which may read information from, and write information to, the storage medium. In another method, the storage medium may be integral with the processor 1100. The processor 1100 and the storage medium may reside within an application specific integrated circuit (ASIC). The ASIC may reside within the user terminal. In another method, the processor 1100 and the storage medium may reside as individual components in the user terminal.

The description above is merely illustrative of the technical idea of the present disclosure, and various modifications and changes may be made by those skilled in the art without departing from the essential characteristics of the present disclosure. Therefore, the embodiments disclosed in the present disclosure are not intended to limit the technical idea of the present disclosure but to illustrate the present disclosure, and the scope of the technical idea of the present disclosure is not limited by the embodiments. The scope of the present disclosure should be construed as being covered by the scope of the appended claims, and all technical ideas falling within the scope of the claims should be construed as being included in the scope of the present disclosure.

According to the present disclosure, in the situation in which the traffic rule violation is inevitably required during the autonomous driving, the alternative route is created using the space in which the travel is prohibited in the traffic rule compliance situation, and the travel is performed along the created alternative route, so that the autonomous vehicle may travel safely by avoiding the traffic accident by itself in the emergency situation.

In addition, according to the present disclosure, the autonomous vehicle may travel safely under the supervision and the control of the remote control center in a non-emergency situation.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A method for autonomous vehicle travel, the method comprising:
determining, by a processor, a travel situation based on vehicle surroundings information during autonomous driving;
classifying, by the processor, a space around the vehicle into a first space, a second space, and a third space based on the vehicle surroundings information;
creating, by the processor, a travel route using at least one of the first space, the second space, and the third space based on the travel situation; and
performing, by the processor, vehicle travel control along the travel route.

2. The method of claim 1, wherein the first space is a space where the autonomous vehicle travel is possible while complying with traffic rules.

3. The method of claim 1, wherein the second space is a space where the autonomous vehicle travel is possible regardless of traffic rules.

4. The method of claim 1, wherein the third space is at least a portion of the second space where avoidance travel is possible.

5. The method of claim 1, wherein the determining of the travel situation includes:
determining, by the processor, whether the travel situation is a first travel situation where accident avoidance is impossible based on the vehicle surroundings information during the autonomous vehicle travel along a normal route planned based on the first space; and
determining, by the processor, whether the travel situation is a second travel situation where the autonomous vehicle travel is impossible along the normal route.

6. The method of claim 5, wherein the creating of the travel route includes:
creating, by the processor, an emergency route using at least one of the first space and the second space when the travel situation is the first travel situation; and
creating, by the processor, an avoidance route using at least one of the first space and the third space when the travel situation is the second travel situation.

7. The method of claim 6, wherein the performing of the vehicle travel control includes:
transmitting, by the processor, the emergency route to a remote control center to request approval; and
transmitting, by the processor, the emergency route to an autonomous driving controller and performing, by the processor, emergency route travel until receiving a rejection for the emergency route from the remote control center.

8. The method of claim 6, wherein the performing of the vehicle travel control includes:
transmitting, by the processor, the avoidance route to a remote control center to request approval; and
transmitting, by the processor, the avoidance route to an autonomous driving controller to perform avoidance route travel when the avoidance route is approved by the remote control center.

9. The method of claim 8, wherein the performing of the vehicle travel control further includes:
determining, by the processor, whether the accident avoidance has been completed when a remote control command is not received from the remote control center; and
returning, by the processor, to the first space when the accident avoidance has been completed.

10. The method of claim 9, wherein the performing of the vehicle travel control further includes:
stopping, by the processor, emergency route travel or the avoidance route travel and controlling, by the processor, the autonomous vehicle travel in response to the remote control command when the remote control command is received from the remote control center.

11. An autonomous vehicle comprising:
a detection device for detecting vehicle surroundings information; and
a processor configured to classify a space around the vehicle into a first space, a second space, and a third space based on the vehicle surroundings information,
wherein the processor is configured to:
determine a travel situation based on the vehicle surroundings information during autonomous driving;
create a travel route using at least one of the first space, the second space, and the third space based on the travel situation; and
perform vehicle travel control along the travel route.

12. The autonomous vehicle of claim 11, wherein the first space is a space where autonomous vehicle travel is possible while complying with traffic rules.

13. The autonomous vehicle of claim 11, wherein the second space is a space where autonomous vehicle travel is possible regardless of traffic rules.

14. The autonomous vehicle of claim 11, wherein the third space is at least a portion of the second space where avoidance travel is possible.

15. The autonomous vehicle of claim 11, wherein the processor is configured to:
determine whether the travel situation is a first travel situation where accident avoidance is impossible based on the vehicle surroundings information during autonomous vehicle travel along a normal route planned based on the first space; and
determine whether the travel situation is a second travel situation where the autonomous vehicle travel is impossible along the normal route.

16. The autonomous vehicle of claim 15, wherein the processor is configured to:
create an emergency route using at least one of the first space and the second space when the travel situation is the first travel situation; and
create an avoidance route using at least one of the first space and the third space when the travel situation is the second travel situation.

17. The autonomous vehicle of claim 16, wherein the processor is configured to:
transmit the emergency route to a remote control center to request approval; and
transmit the emergency route to an autonomous driving controller and perform emergency route travel until receiving a rejection for the emergency route from the remote control center.

18. The autonomous vehicle of claim 16, wherein the processor is configured to:
transmit the avoidance route to a remote control center to request approval; and
transmit the avoidance route to an autonomous driving controller to perform avoidance route travel when the avoidance route is approved by the remote control center.

19. The autonomous vehicle of claim 18, wherein the processor is configured to:
determine whether the accident avoidance has been completed when a remote control command is not received from the remote control center; and
return to the first space when the accident avoidance has been completed.

20. The autonomous vehicle of claim 19, wherein the processor is configured to:
stop emergency route travel or the avoidance route travel and control the autonomous vehicle travel in response to the remote control command when the remote control command is received from the remote control center.
